(19) United States
(12) Patent Application Publication
(10) Pub. No.: US 2007/0226800 A1
(43) Pub. Date: Sep. 27, 2007

(54) Method and system for denying pestware direct drive access

(76) Inventor: Tony Nichols, Erie, CO (US)

Correspondence Address: COOLEY GODWARD KRONISH LLP;ATTN: PATENT GROUP, Suite 500, 1200 - 19th Street, NW, WASHINGTON, DC, 20036-2402, US

(21) Appl. No.: 11/386,595

(22) Filed: Mar. 22, 2006

(51) Int. Cl. G06F 12/14

(52) U.S. Cl. 726/24

(57) ABSTRACT

A method and system for denying pestware direct drive access on a computer is described. In one illustrative embodiment, a driver intercepts a direct drive access by a process running on the computer, and a user interface reports the direct drive access to a user and permits or denies the direct drive access in response to input from the user. In other illustrative embodiments, the user is given the option of permitting or denying a particular running process direct drive access on a one-time or a permanent basis.

### RELATED APPLICATIONS

The present application is related to commonly owned and assigned U.S. application Ser. No. 11/104,202, Attorney Docket No. WEBR-011/00US, “System and Method for Directly Accessing Data From a Data Storage Medium,” filed on Apr. 12, 2005, which is incorporated herein by reference in its entirety.

### FIELD OF THE INVENTION

The present invention relates to protecting computers against pestware or malware. More specifically, but without limitation, the present invention relates to methods and systems for denying pestware or malware direct access to a storage device of a computer.

### BACKGROUND OF THE INVENTION

Protecting personal computers against a never-ending onslaught of “pestware” such as viruses, Trojan horses, spyware, adware, and downloaders on personal computers has become vitally important to computer users. Some pestware is merely annoying to the user or degrades system performance. Other pestware is highly malicious. Still other pestware might even be beneficial to the user. Many computer users depend on anti-pestware software that attempts to detect and remove pestware automatically.

Anti-pestware software typically scans running processes in memory and files contained on storage devices such as disk drives, comparing them, at expected locations, against a set of “signatures” that identify specific, known types of pestware.

Most modern computer operating systems provide two distinct methods for accessing storage devices such as hard disk drives. The standard method is file-level (logical) input/output (I/O). An alternative method, in which I/O is conducted at the sector level directly to and from the storage device, is often called “direct drive access” or “raw I/O.” Direct drive access bypasses some of the checks and controls the operating system applies when file-level I/O is employed. Some types of pestware attempt to access computer storage devices via direct drive access, increasing the potential risk of harm from the pestware infestation. Conventional anti-pestware software may not effectively prevent pestware from using direct drive access.

It is thus apparent that there is a need in the art for an improved method and system for denying pestware direct drive access.

### SUMMARY OF THE INVENTION

Illustrative embodiments of the present invention that are shown in the drawings are summarized below. These and other embodiments are more fully described in the Detailed Description section. It is to be understood, however, that there is no intention to limit the invention to the forms described in this Summary of the Invention or in the Detailed Description. One skilled in the art can recognize that there are numerous modifications, equivalents, and alternative constructions that fall within the spirit and scope of the invention as expressed in the claims.

The present invention can provide a method and system for denying pestware direct drive access on a computer. One illustrative embodiment is a method comprising intercepting a direct drive access by a process running on a computer; reporting the direct drive access to a user; and permitting or denying the direct drive access in accordance with input from the user.

Another illustrative embodiment is a system comprising a driver configured to intercept a direct drive access by a process running on a computer and a user interface configured to report the direct drive access to a user and to permit or deny the direct drive access in accordance with input from the user.

Yet another illustrative embodiment of the invention is a computer-readable storage medium containing program instructions comprising a first instruction segment configured to intercept a direct drive access by a process running on a computer and a second instruction segment configured to report the direct drive access to a user and to permit or deny the direct drive access in accordance with input from the user.

In other illustrative embodiments, the user is given the option of permitting or denying a particular running process direct drive access on a one-time or a permanent basis. These and other embodiments are described in more detail herein.

### BRIEF DESCRIPTION OF THE DRAWINGS

Various objects and advantages and a more complete understanding of the present invention are apparent and more readily appreciated by reference to the following Detailed Description and to the appended claims when taken in conjunction with the accompanying Drawings, wherein:

FIG. 1A is a high-level functional block diagram of a computer protected by an anti-pestware system, in accordance with an illustrative embodiment of the invention;

FIG. 1B is a diagram of a memory of the computer shown in FIG. 1A, in accordance with an illustrative embodiment of the invention;

FIG. 2 is a flowchart of a method for controlling direct drive accesses on a computer, in accordance with an illustrative embodiment of the invention;

FIGS. 3A and 3B are a flowchart of a method for controlling direct drive accesses on a computer, in accordance with another illustrative embodiment of the invention;

FIG. 4A is an illustration of a user interface for controlling direct drive accesses on a computer, in accordance with an illustrative embodiment of the invention; and

FIG. 4B is an illustration of a user interface for controlling direct drive accesses on a computer, in accordance with another illustrative embodiment of the invention.

### DETAILED DESCRIPTION

“Pestware,” as used herein, refers to any program that damages or disrupts a computer system or that collects or reports information about a person or an organization. Examples include, without limitation, viruses, worms, Trojan horses, spyware, adware, and downloaders. As used herein, “a direct drive access” is an input/output (I/O) operation between a process running on a computer and a connected storage device that is conducted at the sector (physical) level rather than at the file (logical) level. “Direct drive access” is also used herein to refer to direct, sector-level I/O in general, as opposed to file-level I/O.

Pestware may be denied direct drive access on a computer by intercepting direct drive accesses, reporting them to a user when necessary, and either permitting or denying them in accordance with present or past input from the user. In an illustrative embodiment, direct drive accesses are intercepted by a driver that hooks the operating system's direct-drive-access application program interfaces (APIs). In this embodiment, the driver preferably hooks an original, unmodified version of each direct-drive-access API before any other process running on the computer has hooked the original, unmodified version of that direct-drive-access API.

In one illustrative embodiment, each direct drive access is reported to the user, and the user may elect to permit or deny the direct drive access without specifying how future direct drive accesses by the associated running process are to be handled.

In another illustrative embodiment, processes associated with the computer's operating system are permitted direct drive access automatically (unconditionally), without the direct drive access being reported to the user and without input being solicited from the user. In this illustrative embodiment, the user can also specify that a particular process should always be permitted to perform direct drive accesses or that the particular process should never be permitted to perform direct drive accesses. To facilitate such an implementation, a list of authorized applications whose associated processes are always permitted direct drive access and a list of unauthorized applications whose associated processes are always denied direct drive access may be maintained.

When a running process attempts a direct drive access, the direct drive access can be intercepted temporarily while it is determined whether the process attempting the direct drive access is associated with the operating system or while the lists of authorized and unauthorized applications are consulted to determine whether the direct drive access should be permitted or denied automatically, without the direct drive access being reported to the user and without input being solicited from the user. If a running process is unknown (i.e., it is associated with neither the operating system, an application on the list of authorized applications, nor an application on the list of unauthorized applications), the direct drive access can be reported to the user, and, via a suitable user interface, the user can specify whether the direct drive access should be permitted or not. For example, the user may permit the direct drive access one time only, specify that direct drive accesses by the associated running process are always permitted, deny the direct drive access one time only, or specify that direct drive accesses by the associated running process are never permitted. Where the user specifies that a particular process should always be permitted to perform direct drive accesses or that it should never be permitted to perform such accesses, the lists of authorized and unauthorized applications, respectively, can be updated accordingly.

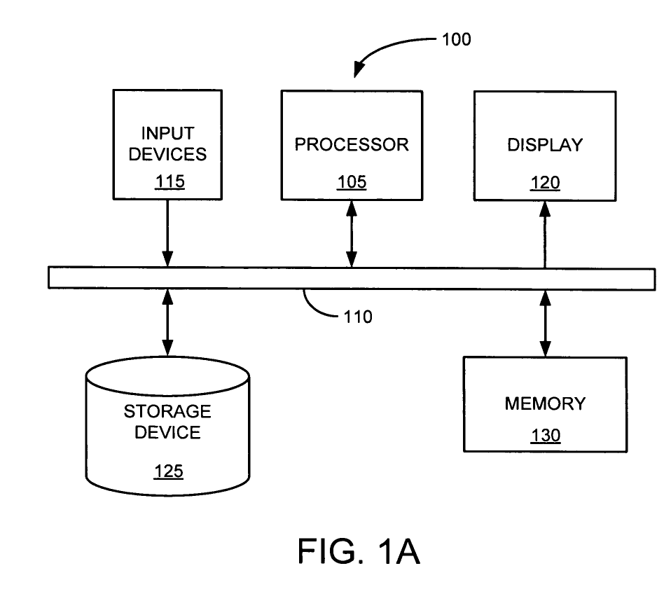

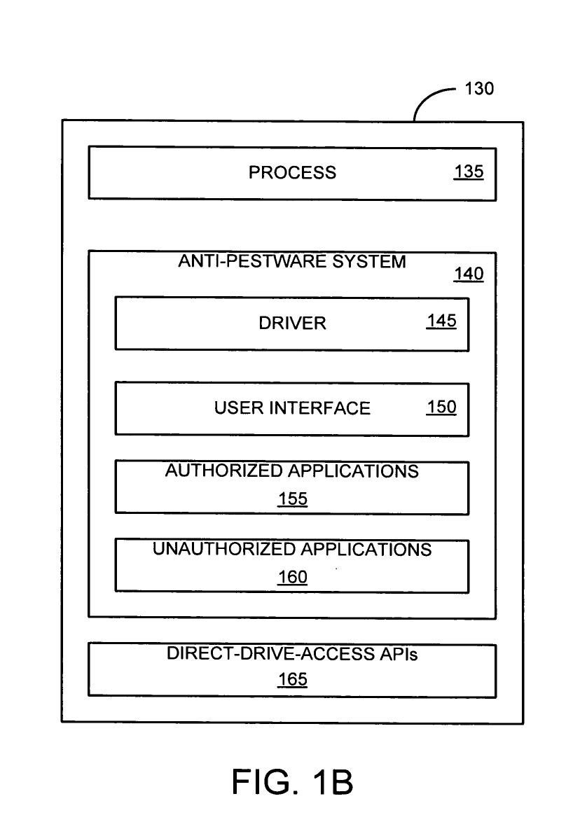

Referring now to the drawings, where like or similar elements are designated with identical reference numerals throughout the several views, FIG. 1A is a high-level functional block diagram of a computer 100 protected by an anti-pestware system, in accordance with an illustrative embodiment of the invention. Computer 100 can be a desktop computer, workstation, laptop computer, notebook computer, handheld computer, or any other device that includes computing functionality. In FIG. 1A, processor 105 communicates over data bus 110 with input devices 115, display 120, storage device 125, and memory 130.

Input devices 115 may be, for example, a keyboard and a mouse or other pointing device. In an illustrative embodiment, storage device 125 is a magnetic-disk device such as a hard disk drive (HDD). In other embodiments, however, storage device 125 can be any type of computer storage device (“drive”), including, without limitation, a magnetic-disk drive, an optical-disc drive, and a storage device employing flash-memory-based media such as secure digital (SD) cards or multi-media cards (MMCs). Memory 130 may include random-access memory (RAM), read-only memory (ROM), or a combination thereof.

FIG. 1B is a diagram of memory 130 of computer 100 shown in FIG. 1A, in accordance with an illustrative embodiment of the invention. In FIG. 1B, memory 130 contains an arbitrary running process (“process”) 135; anti-pestware system 140, which includes driver 145, user interface 150, optional list of authorized applications 155, and optional list of unauthorized applications 160; and direct-drive-access APIs 165.

Anti-pestware system 140 protects computer 100 against pestware by detecting it and, when appropriate, removing it from computer 100. In the illustrative embodiment of FIG. 1B, anti-pestware system 140 is an application program stored on a computer-readable storage medium of computer 100 (e.g., storage device 125) that can be loaded into memory 130 and executed by processor 105. In other embodiments, the functionality of anti-pestware system 140 can be implemented in software, firmware, hardware, or any combination thereof.

For convenience in this Detailed Description, the functionality of anti-pestware system 140 has been divided into two modules, driver 145 and user interface 150. In a data portion of memory 130, anti-pestware system 140 can also, optionally, store and update list of authorized applications 155 and list of unauthorized applications 160. In various embodiments of the invention, the functionality of driver 145 and user interface 150 may be combined or subdivided in ways other than that indicated in FIG. 1B.

Driver 145 is configured to monitor and intercept direct drive accesses on computer 100. In an illustrative embodiment, driver 145 hooks each available direct-drive-access API of the operating system of computer 100. “Hooking” an API is a concept that is well known in the computer programming art. As those skilled in the art are aware, hooking may be used to monitor and intercept events (e.g., API calls) in computer 100. For example, operating systems sold by Microsoft Corporation under the trade name “Windows” (e.g., “Windows XP”) provide a “CreateFile( )” direct-drive-access API that may have arguments such as “\\.\C:”, “\\.\PhysicalDrive0”, “\\.\Harddisk0”, “\\.\Tape0”, “\\.\SCSI”, etc. Windows operating systems also provide direct-drive-access APIs such as “IOCTL₁₃SCSI₁₃PASS₁₃THROUGH₁₃DIRECT” for Small-Computer-System-Interface (SCSI) disk drives and “IOCTL₁₃ATA₁₃PASS₁₃THROUGH₁₃DIRECT” for Advanced Technology Attachment (ATA) disk drives. Driver 145 can hook these and any other avenues to direct drive access, depending on the particular operating system. To guard against pestware modifying direct-drive-access APIs 165 for its own purposes (e.g., through use of a “rootkit”), driver 145 preferably hooks the original, unmodified (operating-system) version of each direct-drive-access API 165 before any other process running on computer 100 has hooked it. In that way, driver 145 has the addresses of the original, unmodified direct-drive-access APIs 165 and can make use of them.

User interface 150 is configured to communicate with a user of computer 100 regarding intercepted direct drive accesses and to receive user input specifying whether to permit those direct drive accesses. Additional details regarding user interface 150 in various embodiments of the invention are provided below.

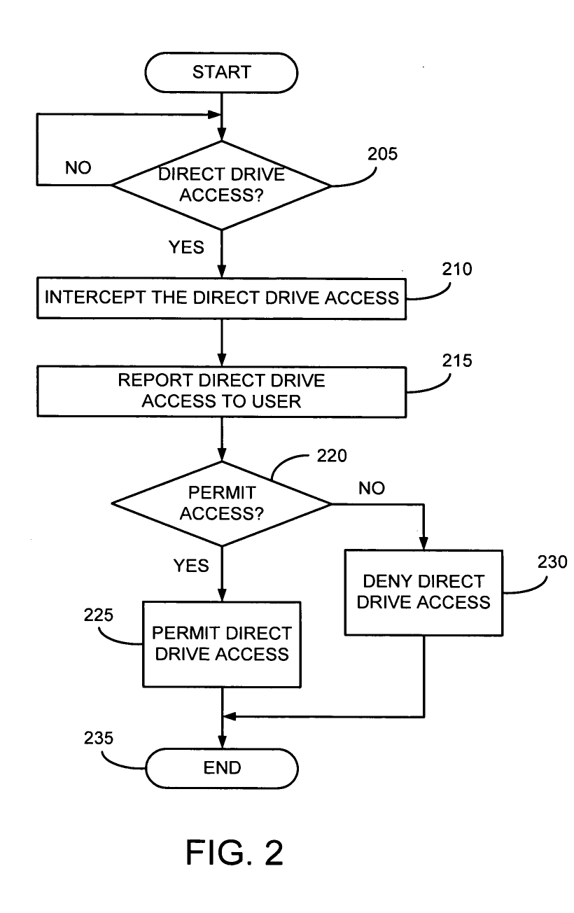

FIG. 2 is a flowchart of a method for controlling direct drive accesses on a computer 100, in accordance with an illustrative embodiment of the invention. If a process 135 has attempted a direct drive access at 205, driver 145 intercepts the direct drive access (e.g., using a hooking technique, as explained above) at 210. At 215, user interface 150 reports to a user the direct drive access intercepted at 210. At 220, user interface 150 receives input from the user. If the user chooses to permit the direct drive access at 220, anti-pestware system 140 permits the direct drive access at 225. If the user chooses to deny the direct drive access at 220, anti-pestware system 140 prevents the direct drive access from occurring at 230. At 235, the method terminates.

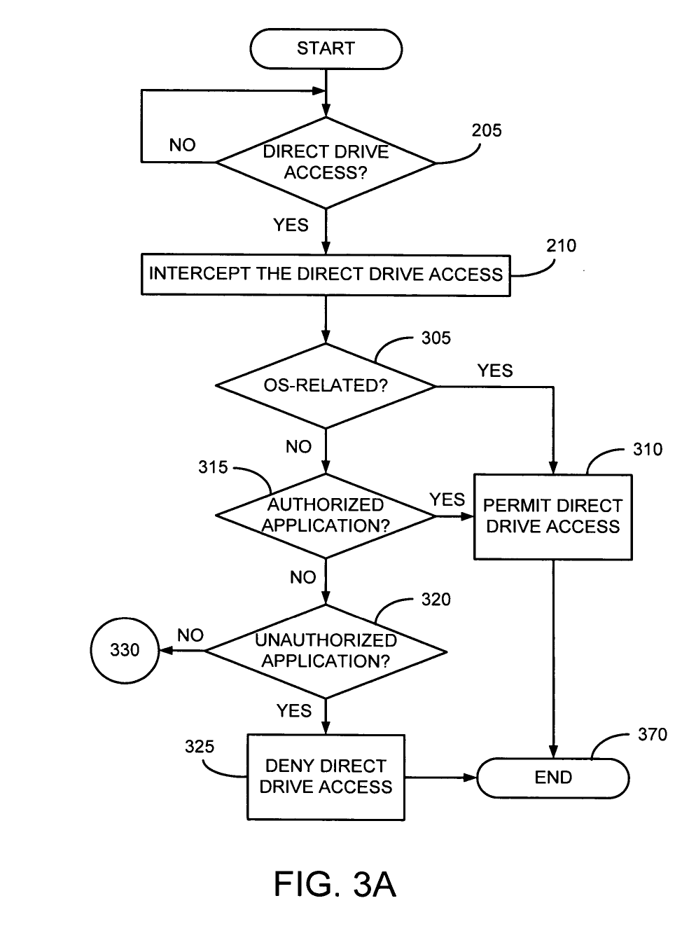

FIGS. 3A and 3B are a flowchart of a method for controlling direct drive accesses on a computer 100, in accordance with another illustrative embodiment of the invention. After steps 205 and 210 in FIG. 2, driver 145 determines, at 305, whether process 135 (the process attempting the direct drive access that was intercepted at 210) is associated with the operating system of computer 100. If so, driver 145 permits the direct drive access at 310, and the method terminates at 370. If process 135 is not associated with the operating system at 305, driver 145 checks, at 315, whether process 135 is associated with an application in list of authorized applications 155. If so, driver 145 permits the direct drive access at 310, and the method terminates at 370. Otherwise, driver 145 checks, at 320, whether process 135 is associated with an application in list of unauthorized applications 160. If so, the direct drive access is denied at 325, and the method terminates at 370. Otherwise, the method proceeds to step 330 in FIG. 3B.

Referring now to FIG. 3B, this portion of the flowchart applies to an unknown process 135 that is associated with neither the operating system of computer 100, an application in list of authorized applications 155, nor an application in list of unauthorized applications 160. At 330, user interface 150 reports to a user of computer 100 the direct drive access intercepted at 210. User interface 150 also presents the user with a set of options from which he or she may select. If the user chooses to permit the intercepted direct drive access one time only (steps 335 and 340), anti-pestware system 140 permits the intercepted direct drive access at 350, and the method then terminates at 370 in FIG. 3A. If the user chooses always (unconditionally) to permit the process 135 associated with the intercepted direct drive access to perform direct drive accesses on computer 100 (steps 335 and 340), user interface 150 adds to list of authorized applications 155 the application with which process 135 is associated at 345, and anti-pestware system 140 permits the intercepted direct drive access at 350.

If the user chooses to deny the intercepted direct drive access one time only (steps 335 and 360), anti-pestware system 140 denies the intercepted direct drive access at 365, and the method then terminates at 370 in FIG. 3A. If the user chooses always (unconditionally) to deny process 135 permission to perform direct drive accesses on computer 100 (steps 335 and 360), user interface 150 adds to list of unauthorized applications 160 the application with which process 135 is associated at 355, and anti-pestware system 140 denies the intercepted direct drive access at 365.

In other embodiments of the invention, user interface 150 may present a different set of options (e.g., a subset of the four options described above in connection with FIGS. 3A and 3B) to the user. FIGS. 2, 3A, and 3B are intended to be merely examples of some possible implementations for user interface 150.

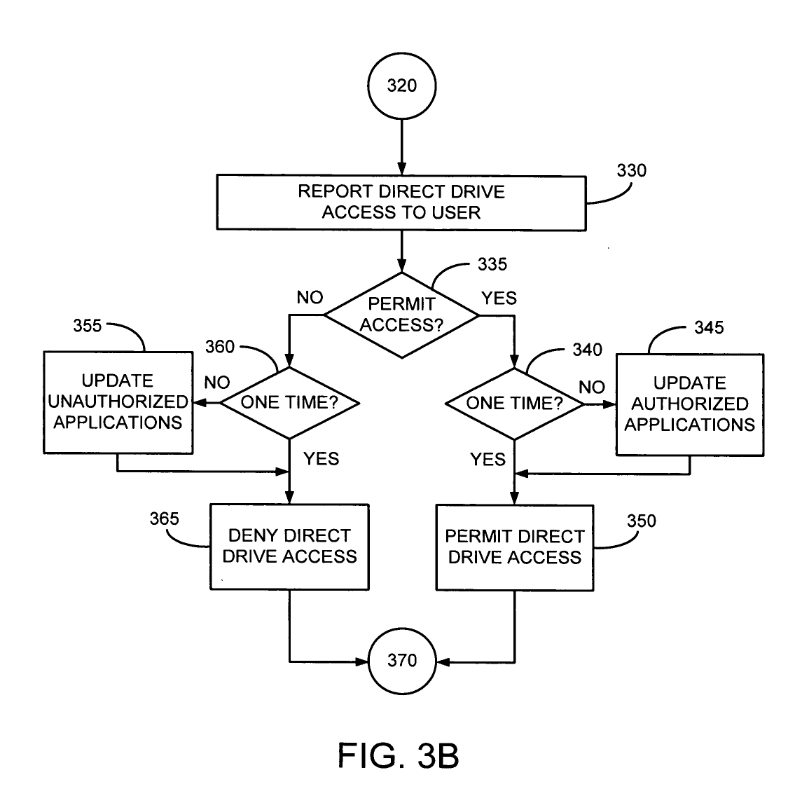

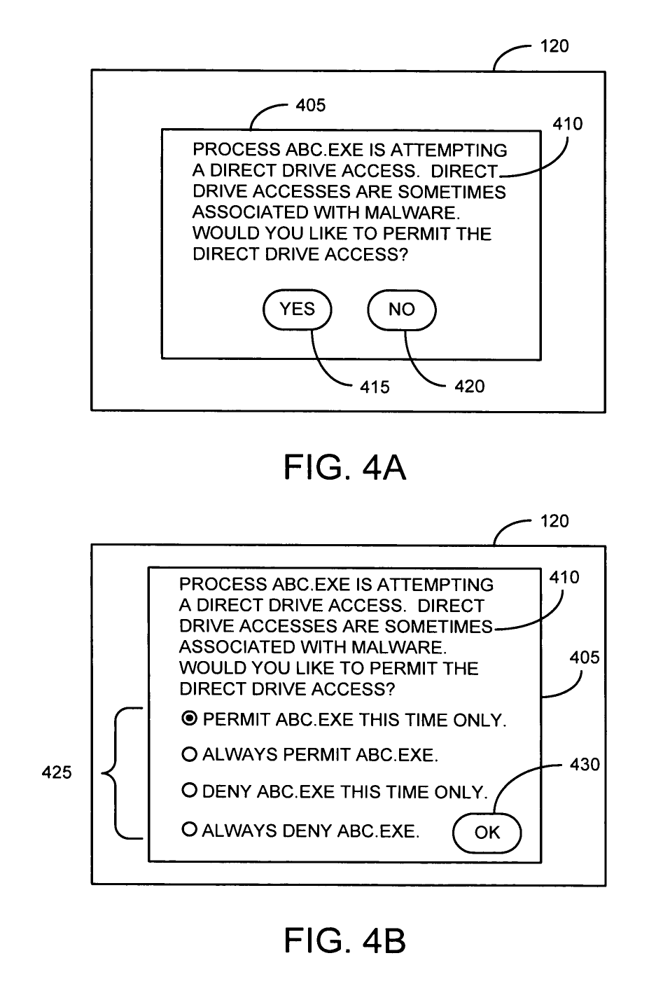

FIG. 4A is an illustration of a user interface 150 for controlling direct drive accesses on computer 100, in accordance with an illustrative embodiment of the invention. In FIG. 4A, user interface 150 displays (e.g., at step 215 in FIG. 2 or step 330 in FIG. 3B) a dialog box 405 on display 120 of computer 100. Dialog box 405 includes a text message 410 explaining that a process (i.e., process 135) is attempting to perform a direct drive access on computer 100. Text message 410 may also explain to the user the significance of a direct drive access and the possible risks associated with it. Text message 410 also prompts the user to permit or deny the intercepted direct drive access. The user may indicate his or her choice by, for example, actuating “yes” activation element 415 or “no” activation element 420 to permit or deny, respectively, the direct drive access. “Yes” activation element 415 and “no” activation element 420 may be, e.g., icons or virtual buttons. These activation elements can be actuated by, for example, a mouse click. The manner in which user interface 150 responds to the user's choice in this illustrative embodiment is explained above in connection with FIG. 2.

FIG. 4B is an illustration of a user interface 150 for controlling direct drive accesses on computer 100, in accordance with another illustrative embodiment of the invention. In FIG. 4B, dialog box 405 includes text message 410, set of options 425, and “OK” button 430. The user may select an option from set of options 425 by actuating the associated “radio button” using, e.g., a mouse. Actuation of “OK” button 430 by the user inputs the selected option to user interface 150. The manner in which user interface 150 responds to the various options 425 in this illustrative embodiment is explained above in connection with FIGS. 3A and 3B.

In other embodiments, user interface 150 may present, on display 120, elements for interacting with the user that appear and operate differently from the illustrative examples shown in FIGS. 4A and 4B. Numerous variations of text message 410, activation elements 415 and 420, set of options 425, and “OK” button 430 are possible, all of which are considered to be within the scope of the invention as claimed.

In conclusion, the present invention provides, among other things, a method and system for denying pestware direct drive access. Those skilled in the art can readily recognize that numerous variations and substitutions may be made in the invention, its use and its configuration to achieve substantially the same results as achieved by the embodiments described herein. Accordingly, there is no intention to limit the invention to the disclosed illustrative forms. Many variations, modifications and alternative constructions fall within the scope and spirit of the disclosed invention as expressed in the claims. For example, though mention has been made above of Windows operating systems, the principles of the invention can be applied to other operating systems such as Linux.

What is claimed is:

1. A method, comprising:
intercepting a direct drive access by a process running on a computer;
reporting the direct drive access to a user; and
performing one of permitting and denying the direct drive access in accordance with input from the user.

2. The method of claim 1, wherein the direct drive access is permitted automatically without the reporting and without input from the user, when the process is associated with an operating system of the computer.

3. The method of claim 1, wherein the direct drive access is permitted automatically without the reporting and without input from the user, when the process is associated with an application in a set of authorized applications.

4. The method of claim 1, wherein the direct drive access is denied automatically without the reporting and without input from the user, when the process is associated with an application in a set of unauthorized applications.

5. The method of claim 1, further comprising:
adding, to a set of authorized applications, an application associated with the process in response to input from the user, processes associated with applications in the set of authorized applications being permitted unconditionally to perform direct drive accesses on the computer, without the reporting and without input from the user.

6. The method of claim 1, further comprising:
adding, to a set of unauthorized applications, an application associated with the process in response to input from the user, processes associated with applications in the set of unauthorized applications being prevented unconditionally from performing direct drive accesses on the computer, without the reporting and without input from the user.

7. The method of claim 1, wherein intercepting includes hooking at least one direct-drive-access application program interface (API) associated with the operating system.

8. The method of claim 7, wherein an original, unmodified version of the at least one direct-drive-access API is hooked before any other process running on the computer has hooked the original, unmodified version of the at least one direct-drive-access API.

9. A method, comprising:
intercepting a direct drive access by a process running on a computer;
permitting the direct drive access, when the process is associated with an operating system of the computer;
permitting the direct drive access, when the process is associated with an application in a set of authorized applications;
denying the direct drive access, when the process is associated with an application in a set of unauthorized applications; and
performing the following, when the process is associated with neither the operating system, an application in the set of authorized applications, nor an application in the set of unauthorized applications:
reporting the direct drive access to a user;
permitting the direct drive access without adding an application associated with the process to the set of authorized applications in response to a first input from the user;
permitting the direct drive access and adding an application associated with the process to the set of authorized applications in response to a second input from the user;
denying the direct drive access without adding an application associated with the process to the set of unauthorized applications in response to a third input from the user; and
denying the direct drive access and adding an application associated with the process to the set of unauthorized applications in response to a fourth input from the user, the first, second, third, and fourth inputs being mutually exclusive.

10. The method of claim 9, wherein intercepting includes hooking at least one direct-drive-access application program interface (API) associated with the operating system.

11. The method of claim 10, wherein an original, unmodified version of the at least one direct-drive-access API is hooked before any other process running on the computer has hooked the original, unmodified version of the at least one direct-drive-access API.

12. A system, comprising:
a driver configured to intercept a direct drive access by a process running on a computer; and
a user interface configured to:
report the direct drive access to a user; and
perform one of permitting and denying the direct drive access in accordance with input from the user.

13. The system of claim 12, wherein the user interface is configured to permit the direct drive access automatically without reporting the direct drive access to the user and without input from the user, when the process is associated with an operating system of the computer.

14. The system of claim 12, wherein the user interface is configured to permit the direct drive access automatically without reporting the direct drive access to the user and without input from the user, when the process is associated with an application in a set of authorized applications.

15. The system of claim 12, wherein the user interface is configured to deny the direct drive access automatically without reporting the direct drive access to the user and without input from the user, when the process is associated with an application in a set of unauthorized applications.

16. The system of claim 12, wherein the user interface is further configured to:
add, to a set of authorized applications, an application associated with the process in response to input from the user; and
permit unconditionally processes associated with applications in the set of authorized applications to perform direct drive accesses on the computer, without reporting the direct drive accesses to the user and without input from the user.

17. The system of claim 12, wherein the user interface is further configured to:
add, to a set of unauthorized applications, an application associated with the process in response to input from the user; and
prevent unconditionally processes associated with applications in the set of unauthorized applications from performing direct drive accesses on the computer, without reporting the direct drive accesses to the user and without input from the user.

18. The system of claim 12, wherein the driver is configured to intercept the direct drive access by hooking at least one direct-drive-access application program interface (API) associated with the operating system.

19. The system of claim 18, wherein the driver is configured to hook an original, unmodified version of the at least one direct-drive-access API before any other process running on the computer has hooked the original, unmodified version of the at least one direct-drive-access API.

20. A computer-readable storage medium containing program instructions, comprising:
a first instruction segment configured to intercept a direct drive access by a process running on a computer; and
a second instruction segment configured to:
report the direct drive access to a user; and
perform one of permitting and denying the direct drive access in accordance with input from the user.
